(19) United States
(12) Patent Application Publication
(10) Pub. No.: US 2005/0240690 A1
(43) Pub. Date: Oct. 27, 2005

(54) Circuit arrangement having a basic function and a monitoring function

(75) Inventor: Dietmar Schmid, Villmar (DE)

Correspondence Address: COHEN, PONTANI, LIEBERMAN & PAVANE, Suite 1210, 551 Fifth Avenue, New York, NY, 10176, US

(73) Assignee: Siemens Aktiengesellschaft

(21) Appl. No.: 11/112,504

(22) Filed: Apr. 22, 2005

(30) Foreign Application Priority Data
Apr. 23, 2004 (DE) 10 2004 019 874.8

(51) Int. Cl. G06F 13/00

(52) U.S. Cl. 710/52

(57) ABSTRACT

A circuit arrangement includes a first circuit group for performing a basic function and a second circuit group for performing a monitoring function. A message buffer provided for buffer-storing data to be output. The message buffer is divided into regions, each region being permanently associated with one of the circuit groups and is accessible only by the respective associated circuit group.

### BACKGROUND OF THE INVENTION

1. Field of the Invention

The invention relates to a circuit arrangement having a first circuit group for performing a basic function and a second circuit group for performing a monitoring function.

2. Description of the Related Art

Some circuit arrangements include circuit groups which perform a function, referred to as a basic function below, integrated with other circuit groups which are used to monitor the circuit groups which perform the basic function. This is the case even for safety-related/security-related applications.

If a serial interface is used to output data associated with the basic function and to output status reports associated with the monitoring function, the information needs to be handled by a common circuit part such as, for example, a microcomputer. This entails the risk of both the data associated with the basic function and the status reports associated with the monitoring function being corrupted if this common circuit part fails. If both sets of data are corrupted, incorrect data related to the basic function may, for example, no longer be identified as errata by the monitoring function.

### SUMMARY OF THE INVENTION

It is an object of the invention to increase the reliability with which status reports associated with a monitoring function are output.

According to the present invention, the object is achieved by providing a message buffer for buffer-storing data to be output, wherein the message buffer is divided into discrete regions. Each of the regions is permanently associated with one of a plurality of circuit groups in a circuit arrangement. Each of regions is accessible only by the circuit group with which it is associated. The circuit arrangement may also contain at least one microcomputer, wherein the microcomputer is arranged in a further region.

The permanent association between the regions of the message buffer and the circuit groups and between the further region and the microcomputer is hard-wired. That is, the associations and regions are prescribed when the integrated circuit is being manufactured, such that the data which are associated with each of the basic function and the monitoring function and that are to be output are prevented from being mixed. As a result, the individual bits in the message buffer are accessed even without an interposed circuit part. An error in the basic function therefore does not affect the outputting of data associated with the monitoring function and vice versa.

In one embodiment of the inventive circuit arrangement, the basic function is the operation of a sensor. In this case, operation of the sensor may comprise the amplification and processing of the signals produced at the actual sensor element and the generation of the voltages and signals needed to operate the sensor element.

The circuit group with the monitoring function may cyclically monitor the first circuit group and write the results to that region of the message buffer which is associated with the second circuit group.

To increase the reliability and flexibility further when the inventive circuit arrangement is incorporated into higher-order systems, the circuit groups may each have outputs which are independent of the message buffer.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

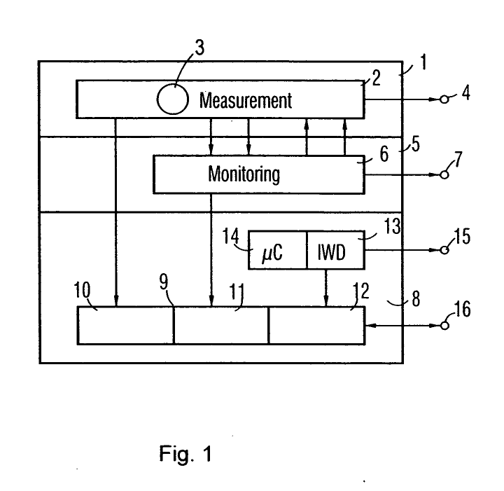

The invention permits numerous embodiments. One of them is shown schematically in the drawing and is described below. FIG. 1 shows a block diagram of an integrated circuit for operating a sensor according to the present invention.

### DETAILED DESCRIPTION OF THE PRESENTLY PREFERRED EMBODIMENTS

FIG. 1 is a block diagram of a circuit arrangement 20 for operating a sensor 3. The sensor 3 may, for example, comprise a rotation rate sensor. The circuit comprises a first circuit group 1 which performs a basic function 2. In this case the basic function involves taking measurements at the sensor 3. Operation of the sensor 3 by the first circuit group 1 may comprise the amplification and processing of the signals produced at the actual sensor element 3 and the generation of the voltages and signals needed to operate the sensor element 3. The first circuit group 1 has an output 4 from which an analog measurement signal, for example, may be taken. The output 4 of circuit group 1 is independent from other circuit groups in the circuit arrangement 20.

The second circuit group 5 performs a monitoring function 6. To accomplish this, the second circuit group 5 is connected to the first circuit group 1 and carries out tests on the first circuit group 1. The tests may be purely passive or may be carried out on the basis of particular test signals which are supplied to the first circuit group 1 cyclically, e.g., every 50 ms, by the second circuit group 5. The second circuit group 5 likewise has an output 7, from which an alarm signal, for example, can be taken. The output 7 of the second circuit group is independent, e.g., separate from other circuit groups in the circuit arrangement 20.

A third circuit group 8 contains a message buffer 9 which is divided into three regions 10, 11, 12. The output data associated with the basic function 2 and the monitoring function 6 are written to the regions 10 and 11, respectively. A third region 12 of the message buffer 9 is connected to an intelligent watchdog circuit 13 which interacts with a microcomputer 14. The watchdog circuit 13 has a first output 15 for outputting an error message, for example to a microcomputer in a higher-order system or to an independent disconnection apparatus, and a further output which is connected to the region 12. The message buffer 9 may be connected to an interface 16 such as, for example, serial peripheral interface (SPI), may be used to read the contents of the message buffer 9 independently of the other parts of the integrated circuit arrangement 20.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A circuit arrangement, comprising:
a first circuit group for performing a basic function of the circuit arrangement;
a second circuit group for performing a monitoring function; and
a message buffer for buffer-storing data to be output, said message buffer being divided into regions, wherein a first region of said regions is permanently associated with said first circuit group and is accessible only by said first circuit group such that said first region receives data only from said first circuit group and a second region of said regions is permanently associated with said second circuit group and is accessible only by said second circuit group such that said second region receives data only from said second circuit group, whereby an error in one of the basic and monitoring functions does not affect the output of data associated with the other of the basic and monitoring functions.

2. The circuit arrangement of claim 1, further comprising at least one microcomputer, said message buffer having a third region associated with said at least one microcomputer.

3. The circuit arrangement of claim 1, further comprising a sensor, the basic function being operation of the sensor.

4. The circuit arrangement of claim 1, wherein said second circuit group with the monitoring function is arranged for cyclically monitoring said first circuit group and writing results to said second region of said message buffer associated with said second circuit group.

5. The circuit arrangement of claim 1, wherein each of the first and second circuit groups has an output that is independent of said message buffer.

6. The circuit arrangement of claim 1, further comprising a third circuit group comprising at least one microcomputer and said message buffer, said message buffer having a third region associated with said at least one microcomputer, and wherein each of said first, second and third circuit groups has an output that is independent of said message buffer.
